(19) United States
(12) Patent Application Publication
(10) Pub. No.: US 2004/0165048 A1
(43) Pub. Date: Aug. 26, 2004

(54) Ink filling method

(75) Inventors: Kuo-Tong Ma, Taipei (TW); In-Shan Sir, Kaohsiung (TW); Yuh-Ming Hsieh, Taoyuan (TW); Fan-Chung Tseng, Hsinchu (TW)

Correspondence Address: Richard P. Berg, Esq., c/o LADAS & PARRY, Suite 2100, 5670 Wilshire Boulevard, Los Angeles, CA, 90036, US

(73) Assignee: BENQ CORPORATION

(21) Appl. No.: 10/783,475

(22) Filed: Feb. 20, 2004

(30) Foreign Application Priority Data
Feb. 25, 2003 (TW) 92103921

(51) Int. Cl. B41J 2/175

(52) U.S. Cl. 347/93

(57) ABSTRACT

A method for filling an ink into an ink cartridge. A filter or an ink passage is treated with a surfactant to increase its hydrophilicity. Therefore, during ink filling, the ink can pass through the filter smoothly or air in the ink passage can be purged without any external force such as a vacuum, thus preventing cracks in the nozzle on the printhead chip.

### BACKGROUND OF THE INVENTION

1. Field of the Invention

The present invention relates to a process for filling ink into an ink cartridge, and more particularly to a process for filling ink smoothly or purging air in the ink passage by treating a filter or an ink passage with a surfactant.

2. Description of the Related Art

Inkjet printing technology is highly developed and well known in the art. The advantages of inkjet printing include low price, low noise, and good full-color printing quality. Additionally, a variety of substrates can be printed on, including plain paper, paper for special printing, and transparencies. Inkjet printing is a non-contact method that involves ejecting ink droplets onto a recording substrate.

There are three general types of inkjet cartridges for inkjet printers. The first type is for use in a printer installed with a printhead, such as an Epson printer. The second type is separate from the printhead and printer, and is used, for example, in Canon printers. The third type is integrated with a printhead, and is used, for example, in HP and Lexmark printers.

There are many methods for filling ink into an ink cartridge, but generally a vacuum ink filling system is used. For a cartridge without a printhead, the method involves creating a vacuum in the closed ink cartridge, filling the ink cartridge with ink in a vacuum, packaging the ink cartridge, and then installing it in a printer. Next, ink is sucked out by a small vacuum pump in the printer itself enabling ink to reach the nozzle.

Referring to FIG. 3, for an ink cartridge with a printhead, the ink filling method involves filling ink into a cartridge 50, and then applying a vacuum to the nozzle (not shown) in the printhead 52 to provide pressure. Thus, ink will pass through the filter 54 and then reach the nozzle on the chip of the printhead 52 via the ink passage 56. Finally, the ink cartridge is packaged. If there are bubbles in the nozzle, printing quality decreases. In contrast, excess gas in the filter 54 and the ink passage 56 can be simultaneously evacuated by the above-mentioned vacuum, thus preventing clogging of nozzle due to bubbles. Related descriptions can be found in U.S. Pat. No. 5,801,735, No. 5,946,015, and No. 6,053,604.

During the ink filling process by vacuum for an ink cartridge with a printhead, a hydrophobic filter is typically employed, but resists ink passage through the filter. That is, when the ink from the ink cartridge 50 passes through the filter 54, the contact angle between the pore of the filter 54 and the ink is greater than 90 degrees. Therefore, an external force (such as vacuum pressure) must be applied to force the ink to pass through the filter 54. The chip, however, is easily damaged by the strong vacuum pressure, and may result in cracks in the nozzle. Moreover, the process is complicated and time-consuming.

### SUMMARY OF THE INVENTION

Therefore, an object of the present invention is to solve the above-mentioned problems and provide a method for filling ink into an ink cartridge. Ink can pass through the filter smoothly or air in the ink passage can be purged without using any external force such as vacuum force. Therefore, crack of the printhead chip can be prevented and the filling process is simplified, thus reducing production cost. In addition, the physical property of the ink does not change.

To achieve the above objects, according to a first aspect of the present invention, the method for filling ink into an ink cartridge includes the following steps. A filter is first treated with a surfactant to increase the hydrophilicity of the filter. Next, the treated filter is installed in an ink cartridge. Finally, ink is filled into the ink cartridge to pass through the treated filter. Therefore, ink can pass through the filter smoothly.

According to a second aspect of the present invention, the method for filling an ink into an ink cartridge includes the following steps. A filter is first installed in an ink cartridge. Next, the filter is treated with a surfactant to increase the hydrophilicity of the filter or the ink passage. Then, ink is filled into the ink cartridge and passes through the treated filter.

According to a third aspect of the present invention, the method for filling an ink into an ink cartridge includes the following steps. An ink cartridge having an ink passage is provided. The wall of the ink passage is treated with a surfactant to increase the hydrophilicity of the wall of the ink passage. Finally, ink is filled into the ink cartridge to pass through the treated the ink passage. Thus, air in the ink passage can be purged without using any external force such as vacuum force.

### BRIEF DESCRIPTION OF THE DRAWING

FIG. 1 shows the contact angle between the filter pore and the ink when the ink is passing through the conventional untreated hydrophobic filter.

FIG. 2 shows the contact angle between the filter pore and the ink when the ink is passing through the treated hydrophilic filter of the present invention.

FIG. 3 is a cross-sectional view of an ink cartridge including a printhead.

FIG. 4 is a flowchart of the ink filling method according to a first embodiment of the present invention.

FIG. 5 is a flowchart of the ink filling method according to a second embodiment of the present invention.

FIG. 6 is a flowchart of the ink filling method according to a third embodiment of the present invention.

### DETAILED DESCRIPTION OF THE INVENTION

The main feature of present invention is treating a filter or an ink passage with a surfactant to increase the hydrophilicity of the filter or the ink passage. For example, a hydrophobic filter becomes hydrophilic after treatment. The hydrophilicity of the filter enables ink to pass smoothly through the filter then flow into the nozzle of the printhead during filling. Therefore, ink flows through the filter smoothly without requiring any external force such as vacuum pressure. Thus, cracks in the printhead chip are prevented.

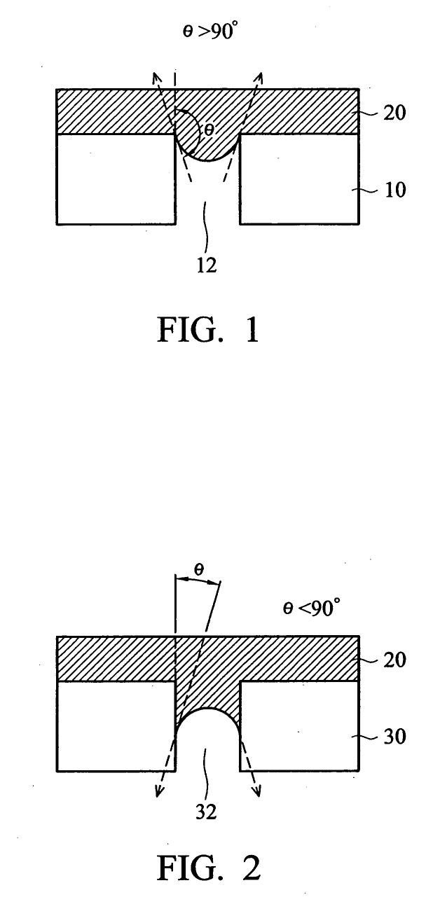

The contact angle θ described in the present invention is defined as the angle between the pore of the filter and the ink surface. Referring to FIG. 1, when the filter 10 is hydrophobic, the ink 20 cannot easily flow into the pore 12 of the filter 10; thus, the resulting contact angle θ is greater than 90 degrees. Referring to FIG. 2, when the filter 30 is hydrophilic, ink 20 flows easily into the pore 32 of the filter; thus, the resulting contact angle θ is less than 90 degrees. The pressure difference AP generated by the surface tension of the ink on the filter can be deduced from formula 1

ΔP=2σ(cos θ)/r (formula 1)

wherein r is the average radius of the filter pore, σ is the surface tension of the ink, and θ is the contact angle.

When the contact angle is less than 90 degrees, the pressure difference forces the ink to pass through the filter. When the contact angle is greater than 90 degrees, the pressure difference resists passage of the ink through the filter.

A hydrophobic filter is typically employed during the filling process. The contact angle θ between the filter pore and the ink during filling is greater than 90 degrees and resisting passage of ink through the filter as shown in FIG. 1. The object of treating a filter with a surfactant in the present invention is to increase the hydrophilicity of the filter. After treatment, the contact angle between the pore of the treated filter and the ink surface is decreased to preferably less than 90 degrees as shown in FIG. 2, and more preferably to 0 to 45 degrees. Thus, during filling, the contact angle between the filter pore and the ink surface is decreased due to intermolecular attraction between the ink and the filter, such as Van der Vaals bonds, polar bonds, or hydrogen bonds. As a result, the ink can pass smoothly through the filter, flow into the ink passage, and then reach the nozzle. In addition, treating the filter with a surfactant and then performing ink filling will not change the physical properties of the ink.

The present invention provides three ink filling methods. Referring to FIG. 4, the first method involves first treating a filter with a surfactant (step S41), and then installing the treated filter in an ink cartridge (step S42). The filter treatment method is not limited. For example, the filter can be immersed entirely in the surfactant, or the surfactant can be dropped onto the filter. Finally, ink fills the ink cartridge and passes through the treated filter (step S43).

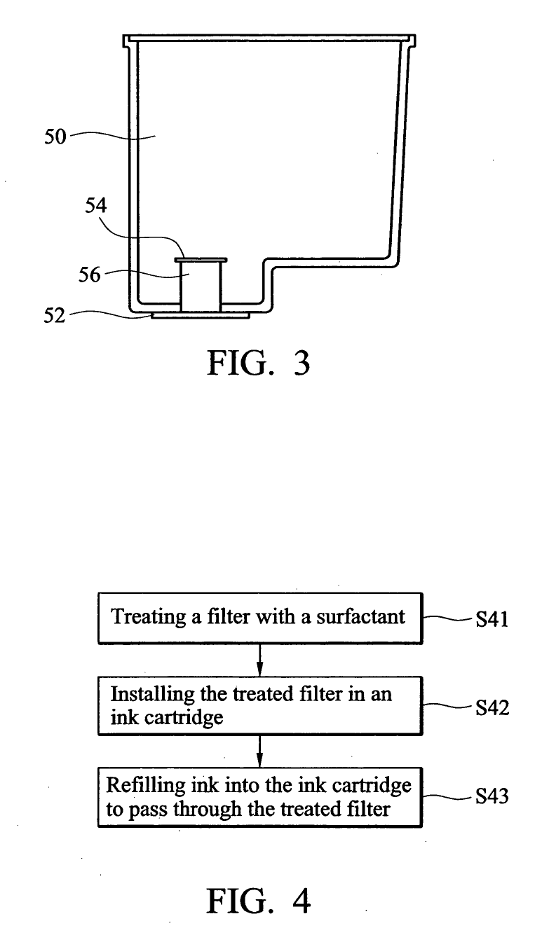

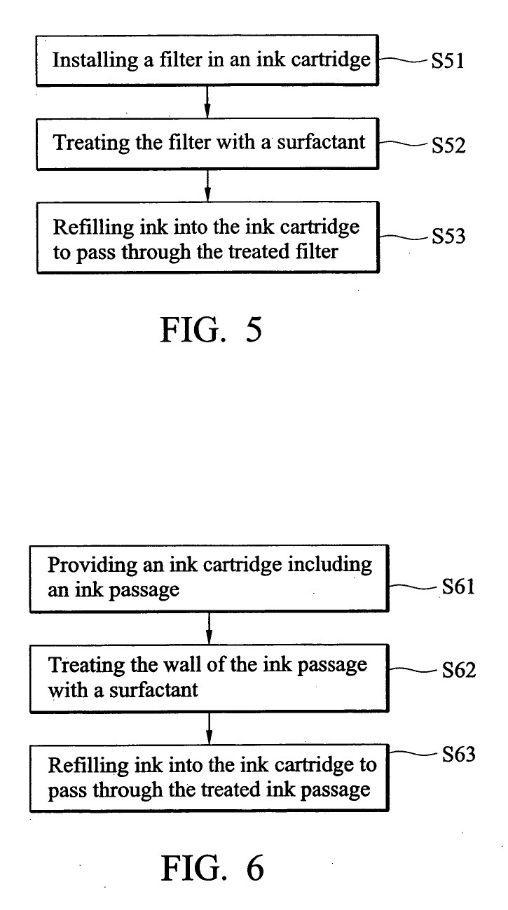

The second method involves first installing a filter in an ink cartridge and then treating the filter with a surfactant. For example, referring to FIG. 5, first, a filter is installed in an ink cartridge (step S51). Next, the filter is treated with a surfactant (step S52). For example, the surfactant is dropped onto the filter, or the filter is immersed in surfactant. Finally, ink fills the ink cartridge and passes through the treated filter (step S53). Referring to FIG. 3, by means of such treatment, when the surfactant is dropped onto the filter 54, since the filter 54 has been installed in the ink cartridge 50, both the filter 54 and the wall of the ink passage 56 become hydrophilic. Thus, ink flows smoothly, preventing generation of bubbles.

The third method treats the ink passage with a surfactant. Referring to FIG. 6, first, an ink cartridge including an ink passage is provided (step S61). Next, the wall of the ink passage is treated with a surfactant (step S62). Finally, ink fills the ink cartridge and passes through the treated filter (step S63). In an ink-jet printer, the filter in the ink cartridge filters impurities in ink and also prevents residue in the foam from flowing into the ink passage, thus preventing clogging of the print-head nozzle. The filter suitable for use in the present invention can be a fiber filter, a nylon filter, a foam filter, or a metal filter. A metal filter such as a stainless steel filter is preferable. A frequently-used stainless steel filter can be formed by inserting stainless steel fiber into copper or aluminum to enhance strength and elasticity. The stainless steel filter can include Fe:20-30%, Cr:6-20%, Ni:2-8%, Mo:0.5-2%, Zn:1-5%, Pb:0.5-2%, and S:0.1-1%.

Conventionally, a surfactant plays a very important role in an inkjet printer. The addition of a suitable amount of surfactant will impart the ink not only with suitable viscosity and surface tension, thus making ink-delivery and ink-ejection smoother, but also with suitable surface tension, thus preventing ink bleeding. In addition, dispersion of other additives and permeation of paper and other substrates is improved.

It should be noted, however, that treating a filter with a surfactant in the present invention is different from adding a surfactant to an ink. In the present invention, first, a filter or an ink passage is treated with a surfactant, and the ink cartridge is then filled with ink. Whether the ink for filling contains a surfactant or not is not the key point of the present invention.

The surfactant suitable for use in the present invention to treat the filter or ink passage to increase its hydrophilicity is not limited. For example, the surfactant can have an HLB value of 3 to 18, preferably 6 to 15. Hydrophilicity or hydrophobility of a surfactant is defined by HLB (hydrophilic lipophilic balance). Calculation of HLB has been developed by Griffin, as shown in formula 2. Generally, HLB indicates the ratio of hydrophilic functional groups in the molecule structure of the surfactant. A higher HLB represents better hydrophilicity of the surfactant and good solubility in water and vice versa.

HLB=(molecular weight of hydrophilic structure/total molecular weight)×20 (formula 2)

In the present invention, the surfactant can be used singly or dissolved in a solvent for use. That is, the surfactant can be used singly to treat the filter or the ink passage, or the surfactant can be first dissolved in a solvent and then the surfactant solution is used to treat the filter or ink passage. The solvent for dissolving the surfactant can be water or a hydrophilic solvent. The surfactant can be used in an amount of 0.0001 to 10 weight %. In addition, a general ink formulation without a colorant can also be used to treat the filter or ink passage, since the general ink formulation contains a surfactant. In this way, the surfactant already contained in the ink can increase the hydrophilicity of the filter or the ink passage.

The surfactant suitable for use in the present invention can be one or combinations of the following commercial products, A-102 from CYTEC, LF-4 from CYTEC, OT-75 from CYTEC, GPG from CYTEC, OT-70PG from CYTEC, 1,3-BG from KYOWA, OG from KYOWA, BEPG from KYOWA, PD-9 from KYOWA, Surfynol EP-810 from AIR PRODUCT, Sufynol CT-141 from AIR PRODUCT, Surfynol CT-151 from AIR PRODUCT, Sufynol 420 from AIR PRODUCT, Surfynol 440 from AIR PRODUCT, Sufynol 465 from AIR PRODUCT, Surfynol 485 from AIR PRODUCT, Sufynol 502 from AIR PRODUCT, Surfynol 504 from AIR PRODUCT, Sufynol FS-80 from AIR PRODUCT, Surfynol TG from AIR PRODUCT, Sufynol GA from AIR PRODUCT, Surfadone LP-100 from ISP, Surfadone LP-300 from ISP, Canocol C-10 from Centro Chino Corp., Canocol C-45 from Centro Chino Corp., Canocol L-30 from Centro Chino Corp., Canocol L-50 from Centro Chino Corp., Canocol O-6 from Centro Chino Corp., Canocol MO200 from Centro Chino Corp., Canocol MO400 from Centro Chino Corp., Canocol MO600 from Centro Chino Corp., Canocol DO400 from Centro Chino Corp., Canocol DO600 from Centro Chino Corp., Canocol ML200 from Centro Chino Corp., Canocol ML400 from Centro Chino Corp., Canocol ML600 from Centro Chino Corp., Canocol T-40 from Centro Chino Corp., Canocol S-80 from Centro Chino Corp., Canocol NP-6 from Centro Chino Corp., Canocol CME from Centro Chino Corp., Canocol CKD from Centro Chino Corp., Tergitol 15-S-5 from UCC, Tergitol 15-S-7 from UCC, or Tergitol XD-75 from UCC.

When the surfactant is dissolved in a solvent and then the filter or the ink passage is treated with the surfactant solution, the solvent that dissolves the surfactant can be a hydrophilic solvent, such as an organic solvent. Suitable organic solvents can be cyclohexane, methanol, ethanol, 2-propanol, γ-butyrolactone, 2-pyrrolidone, N-methyl-2-pyrrolidone, 2,4,7,9-tetramethyl-5-decyne-4,7-diol, 1,1,1-trimethylolpropane, ethylene glycol, di-1,2-propylene glycol, diethylene glycol, triethylene glycol, polyethylene glycol, propylene glycol, butylene glycol, pentylene glycol, hexylene glycol, or polyhydric alcohol.

The following examples are intended to illustrate the process and the advantages of the present invention more fully without limiting its scope, since numerous modifications and variations will be apparent to those skilled in the art.

### EXAMPLE 1

The metal filters used in this example were 15MO(Pall), Z86(Pall), and Z98(Pall).

0.15 g of surfactant Surfynol 440 (HLB=8, from AIR PRODUCT) was dissolved in 99.85 g of deionized water to prepare a surfactant solution. The surfactant solution was then dropped on the 15MO filter. Water was then dropped on the 15MO filter to observe permeation of water droplets. In addition, the Z86 and Z98 filters were subjected to the same test.

The result shows that water droplets had good permeation on three metal filters. Water droplets passed through the metal filters easily without any external force and no water droplets remained on the filters.

### EXAMPLE 2

The metal filters used in this example were 15MO(Pall), Z86(Pall), and Z98(Pall).

0.5 g of surfactant Tergitol 15-S-5 (HLB=10.6, from UCC) was dissolved in 99.5 g of deionized water to prepare a surfactant solution. The surfactant solution was then dropped on the 15MO filter. Water was then dropped on the 15MO filter to observe permeation of water droplets. In addition, the Z86 and Z98 filters were subjected to the same test.

The result shows that water droplets had good permeation on three metal filters. Water droplets passed through the metal filters easily without any external force and no water droplets remained on the filters.

### EXAMPLE 3

The metal filters used in this example were 15MO(Pall), Z86(Pall), and Z98(Pall).

0.5 g of surfactant Tergitol XD-75 (HLB=12, from UCC) was dissolved in 99.5 g of deionized water to prepare a surfactant solution. The surfactant solution was then dropped on the 15MO filter. Water was then dropped on the 15MO filter to observe permeation of water droplets. In addition, the Z86 and Z98 filters were subjected to the same test.

The result shows that water droplets had good permeation on three metal filters. Water droplets passed through the metal filters easily without any external force and no water droplets remained on the filters.

### COMPARATIVE EXAMPLE 1

The metal filters used in this example were 15MO(Pall), Z86(Pall), and Z98(Pall).

Water was dropped on the three metal filters respectively to observe permeation of water droplets. The result shows that water droplets had inferior permeation on three metal filters and remained on the filters. Water droplets were capable of passing through the metal filters only by external force.

### EXAMPLE 4

The metal filters used in this example were 15MO(Pall), Z86(Pall), and Z98(Pall).

1.0 g of surfactant Tergitol 15-S-5 (from UCC), 10.0 g of propene glycol (from Adrich), 1.5 g of 2-pyrrolidone (from Adrich), 6.0 g of polyethylene glycol 900 (from Adrich) and 0.5 g of Mergal K7 (from Clariant) were dissolved in 81.0 g of deionized water to prepare a surfactant solution. This special surfactant solution was an inkjet ink formula but without a coloring material.

Each of the three metal filters was installed in an ink cartridge and assembled with an inkjet nozzle chip. Then, the above special surfactant solution was dropped on the three metal filters respectively. An ink including the above special surfactant solution and 1-7 wt % of a coloring material was then dropped to observe its permeation.

The result shows that the ink had good permeation on the three metal filters. The ink passed through the filters easily without any external force and no ink remained on the filters.

### COMPARATIVE EXAMPLE 2

The metal filters used in this example were 15MO(Pall), Z86(Pall), and Z98(Pall).

Each of the three metal filters was installed in an ink cartridge and assembled with an inkjet nozzle chip. The same ink used in Example 4 was then dropped to observe its permeation.

The result shows that the ink had inferior permeation on the three metal filters and remained on the filters. The ink was capable of passing through the filters only by an external force.

In conclusion, in the present invention, by means of first using a surfactant solution or an ink formulation without a colorant to treat the filter and then dropping an ink onto the filter, the ink passes through the filter smoothly without applying any external force and the ink has good permeation.

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for filling an ink into an ink cartridge, comprising:
treating a filter with a surfactant to increase the hydrophilicity of the filter, wherein the filter has pores;
installing the treated filter in an ink cartridge; and
filling an ink into the ink cartridge to pass through the treated filter.

2. The method as claimed in claim 1, wherein when the ink is filled into the ink cartridge, the pore of the filter and the ink surface are at an angle less than 90 degrees.

3. The method as claimed in claim 1, wherein the filter is a fiber filter, nylon filter, foamed filter, or metal filter.

4. The method as claimed in claim 1, wherein the surfactant has an HLB value of 3 to 18.

5. The method as claimed in claim 4, wherein the surfactant has an HLB value of 6 to 15.

6. The method as claimed in claim 1, wherein the surfactant is used singly.

7. The method as claimed in claim 1, wherein the surfactant is dissolved in a solvent when used.

8. The method as claimed in claim 7, wherein the solvent is water or a hydrophilic solvent.

9. The method as claimed in claim 7, wherein the surfactant is present in an amount of 0.0001 to 10 weight %.

10. A method for filling an ink into an ink cartridge, comprising:
installing a filter in an ink cartridge, wherein the filter has pores;
treating the filter with a surfactant to increase the hydrophilicity of the filter; and
filling an ink into the ink cartridge to pass through the treated filter.

11. The method as claimed in claim 10, wherein when the ink is filled into the ink cartridge, the pore of the filter and the ink surface are at an angle less than 90 degrees.

12. The method as claimed in claim 10, wherein the filter is a fiber filter, nylon filter, foamed filter, or metal filter.

13. The method as claimed in claim 10, wherein the surfactant has an HLB value of 3 to 18.

14. The method as claimed in claim 13, wherein the surfactant has an HLB value of 6 to 15.

15. The method as claimed in claim 10, wherein the surfactant is used singly.

16. The method as claimed in claim 10, wherein the surfactant is dissolved in a solvent when used.

17. The method as claimed in claim 16, wherein the solvent is water or a hydrophilic solvent.

18. The method as claimed in claim 16, wherein the surfactant is present in an amount of 0.0001 to 10 weight %.

19. A method for filling an ink into an ink cartridge, comprising:
providing an ink cartridge having an ink passage, wherein the ink passage has a wall
treating the wall of the ink passage with a surfactant to increase the hydrophilicity of the wall of the ink passage; and
filling an ink into the ink cartridge to pass through the treated the ink passage.

20. The method as claimed in claim 19, wherein the surfactant has an HLB value of 3 to 18.

21. The method as claimed in claim 20, wherein the surfactant has an HLB value of 6 to 15.
